(19) United States
(12) Patent Application Publication
(10) Pub. No.: US 2008/0294640 A1
(43) Pub. Date: Nov. 27, 2008

(54) Pop-Up Software Application

(76) Inventors: James T. Yost, Duluth, GA (US); Daniel B. Cowart, Duluth, GA (US)

Correspondence Address: NEXSEN PRUET, LLC, P.O. BOX 10648, GREENVILLE, SC, 29603, US

(21) Appl. No.: 11/913,024

(22) PCT Filed: Apr. 27, 2006
(86) PCT No.: PCT/US06/15976

§ 371 Date: Jun. 24, 2008

Related U.S. Application Data
(60) Provisional application No. 60/675,366, filed on Apr. 27, 2005.

(51) Int. Cl. H04L 9/32; G06F 15/16; G06F 7/00; G06F 17/30

(52) U.S. Cl. 707/9; 709/202; 707/10; 707/E17.115

(57) ABSTRACT

An information delivery software application that employs “pop-up” software application technology installed on a user's computer to deliver changing content selected by the computer user. In the present application, the pop-up technology that is used to deliver to the consumer in a controlled and constructive manner to deliver content the user specifically requests, and on a regular schedule that the user has set and can change at will. The content may be data files, including text, audio files, video files, image files, RSS feeds, instant messages, Web pages, Internet hyperlinks and can itself contain links to other data files. Each delivery of content to an end-user is captured and logged as a data exchange event that can be tracked by the deliverer of the content.

### BACKGROUND OF THE INVENTION

Computer users who access the Internet are familiar with so-called “pop-up” advertisements. Pop-up advertisements are advertisements in windows that suddenly open on a computer monitor as the result of applications that are launched, not at the request of the computer user but rather in response to an action taken by the user having nothing directly to do with the application thus launched. For example, these pop-up advertisements may appear when a user attempts to close or open a software object window. Traditional pop-up advertisements have become so unwanted that many users install “pop-up blockers” in an attempt to take back control of their own computer.

The reason for the public disdain of pop-up advertisements is twofold. First, typical pop-up advertisements are intrusive. They interrupt the intended course of action of the computer user, and require an additional step on the user's part to return to that intended course. Second, typical pop-ups deliver content that is likely to be undesirable to the recipient, such as advertisements.

The advertising of a pop-up window delivered at an unexpected time is a distraction and a nuisance to the computer user. However, not all interruptions to the tasks of a computer user are undesirable or unscheduled. For example, many time and task management software applications remind computer users of appointments and other calendared items or deadlines. These interruptions, while still distracting from the task at hand, are necessary and are presumably at the user's own request.

A computer user may interrupt what he is doing at times to seek content that is of interest, such as news or weather, stock quotations or sports scores. These diversions provide a mental break from the task at hand and refresh the worker who uses a computer extensively in his or her work. They may also provide information that is important to track. Tracking the approach of bad weather, for example, may be important to the user who expects to be traveling later in the day. People who trade stocks for their own or for others' accounts may need to track changes in stock prices. These individuals may toggle between windows to find the latest information about subjects of interest and their regular tasks.

Thus there remains a need for a better way for computer users to receive content they want while working on the task at hand.

### SUMMARY OF THE INVENTION

According to its major aspects and briefly recited, the present invention is an information delivery software application that employs “pop-up” software application technology installed on a user's computer, cellular telephone or PDA to deliver content selected by the computer user. The content available to the user is comprised of two types, default content and enterprise content. Enterprise content is determined by the organization that provided the software application to the end user. Default content is that which is shown each and every time the pop-up appears on the user's device. Typically, default content will be unrelated to the enterprise content, but greatly desired by the user nonetheless. Examples of default content include, but are not limited to: personal photos, Bible verses, stock quotes, weather reports or other information that the user would like delivered on a periodic basis. Conversely, enterprise content is information provided by the originating organization that is made available through the present software application. Enterprise content preferences are selected by the user during the application installation process from a series of drop-down menus, but they can be changed at any time after installation to reflect the user's changing needs. Examples of enterprise content include, but are not limited to: newsletters, audio/video files, company news and other information that the user desires from the organization. Both default and enterprise content may come from the same computer, cellular telephone or PDA as that being used, from a local area network, or from the world wide web of computers commonly known as the Internet. In the present application, the same technology that is used to launch a pop-up application to deliver unwanted advertisements is here used in a controlled and constructive manner to deliver to the consumer information the user specifically requests, and on a schedule that the user has set and can change. The content may be data files, including text, audio files, video files, image files, RSS feeds, instant messages, Web pages, Internet hyperlinks and can itself contain links to other data files.

For example, a user who trades securities for his own account or who manages accounts for others may want quotes of prices on a selected collection of stocks and bonds to appear on his computer at frequent intervals. Another example might be a sales manager who may want current sales performance information for her sales staff at spaced intervals throughout the day. A corporation may want to send messages out to all employees on a daily basis. Business travelers may want to receive weather condition updates frequently while traveling.

These and other examples will be apparent to those skilled in the art of computer software applications from a careful reading of the Detailed Description of Preferred Embodiments accompanied by the following drawings.

### BRIEF DESCRIPTION OF THE DRAWING

In the drawing,

FIG. 1 is a flow chart illustrating an embodiment of the present invention.

### DETAILED DESCRIPTION OF THE INVENTION

The present invention is a device in the form of a software application for installation on a personal computer, preferably one connected to a local area network or to the Internet, which is a global network of computers operating using certain protocols. The term “personal computer” will be used herein for convenience to include any computer with a monitor, including personal digital assistants and cell phones. The application uses object-based computer programming and user-interface technology well-known to those familiar with current generation software applications available to the general public. This technology includes the desktop metaphor, the windows metaphor, and typical user interface equipment such as keyboards, trackballs, touch pads and mice, as well as actions such as pointing a cursor, and clicking and dragging on software objects viewed in a window on the computer's monitor screen. All of these and others are well-known to computer users and programmers but are selectively combined and used in the present application in a novel and non-obvious combination in a device for use in delivering content to computer users.

While the present invention is referred to as a software application, it is well known that software can be embodied in hardware and thus, a hardware embodiment can be an equivalent of the present software application if it achieves the same result in essentially the same way.

The present invention is a delivery system for changing content and a method for delivering changing content. Content, be it enterprise or default content, refers to data files, including text, audio files, video files, image files, RSS feeds, instant messages, Web pages, Internet hyperlinks and combinations of these that are presented using software objects called windows that are launched by the present application at the end of a pre-selected first time interval and which last until the end of a pre-selected second time interval before being automatically closed. The first time interval is then restarted to repeat the countdown process, with the next content appearing when a window launches at the end of that second first time interval. The selected content resides on computer hard drives, either on the user's own computer, on a server in a local area network, or on a server connected to the Internet. The address of the content is stored with the present application.

The present invention is also a method of adding, modifying and updating the enterprise content made available to a user of the present software application, through a web-enabled, password-protected, administrative portal. The method comprises several steps. The first step is creating a database of links to enterprise content that will be made available to users of the present software application. Access to this database will be provided at different levels ranging from the broad spectrum permission provided to the highest ranking administrative personnel to very limited access granted to departmental personnel, according to a hierarchy pre-determined by the content provider.

The second step is enabling the addition, deletion and modification of enterprise content through a simple, user-friendly interface made available as an active server page (ASP) which is accessible through the administrative portal.

The third step includes automatic updating of every copy of the present software application in use through the modification of the drop-down menus for content selection within each user's personal interface. When enterprise content is modified, the end-user applications will reflect the update in the first window that pops up in each software copy subsequent to the modification.

The present invention may also be viewed as a method of tracking delivered content to a user of a personal computer, again including a cellular telephone or personal digital assistants (PDA) in the definition of personal computer connected to a network. This method starts with the step of downloading the present software application to a personal computer on a network. The downloaded software application is capable of tracking the usage of the personal computer on the network so that the content provider may ascertain individual usage patterns and individual preferences for content delivered through the network using the present software application.

The second step is assigning an individual tracking number (ITN) to the downloaded software application, followed by including the originating ITN with each additional distributed copy of the software application in order to track the originating source.

The next step is to capture the usage statistics of every individual user of the application by combining the ITN with the corresponding information captured during the installation of the present software application in the user registration process. Then the content provider is able to view the captured data, real-time and on-demand, in the form of data table and graphs available through the password-protected administration portal.

An important feature of the present invention is the use of changing content. Changing content means either evolving content, that is, content that is being frequently modified or augmented, or, alternatively, a set of content only part of which is presented at any one time, leaving other parts of that content to be present later. Evolving content, for example, includes specific enterprise content, instant messages, news, weather, stock quotes, and new product information. Sets of content presented in parts include, typically, information to be learned such as vocabulary words, geographical facts, test questions, family photographs and Bible verses. Combinations of the two types of content are also possible, such as monthly sales results for a staff of sale managers can be presented in rotation, one manager at a time.

The window opened by the present application preferably covers only a minor portion of the user's monitor screen rather than the whole screen. Most preferably, the user may specify that it appear at a pre-selected location on the monitor screen, but otherwise it will appear in the bottom right corner of the monitor screen.

As the window opens, it is loaded with content, namely the “current content”, which will remain until the second time interval ends, unless the user moves his cursor over the window, in which case the countdown of the second time interval is stayed. When the second time interval has ended, the window closes. At the end of another first time interval has ended, the application again opens a window but this time the window is loaded with new content, the “next content”, in place of the current content previously loaded.

The present software application resides on the user's personal computer and preferably is based on a platform such as that provided by Microsoft under the trademark .NET. It also includes an implementing application such as that provided by Macromedia under the trademark FLASH. These are preferred simply because they work well and they are accessible to over 95% of the personal computers used throughout the world. Other platforms, such as Apple's Mac OS, the Palm OS, and Linux, and implementing software, will also be acceptable with slight modifications of the present pop-up application.

Other requirements for the present application are equally important. For example, the present application requires a windows-based operating system such as WINDOWS 95 or better, provided by Microsoft, a browser such as INTERNET EXPLORER provided by Microsoft or NAVIGATOR, provided by Navigator, a dial up or better connection to the internet or network connection.

The present software application may have many different embodiments based primarily on the content to be delivered. For example, a stock broker may have a version it provides to those of its customers who have accounts with it that allow the account owners to see midday and close of business day prices for each security in their respective portfolios. As another example, a corporation may make announcements (events, meetings, training sessions, special announcements) during the day to those on its internal network. An entertainment company may distribute the present software to customers who wish to know about new releases. A candidate for public office may want to distribute messages to campaign supporters. In addition to long term uses, there could be shorter term uses, such as use by travelers who wish to monitor new of impending bad weather in the area through which they are traveling. Or, for example, a student studying for a standardized test may use the present application in connection with a set of sample test questions delivered individually at intervals throughout the day while he engages in other work.

Many other examples can be given in which an organization wishes to provide content to those who wish to receive it, content that is deliverable at intervals and that changes in some way each time it is delivered so that the recipient would want to receive the most current content or the next content in a set of content.

The present software application may be distributed widely and easily at times in order to induce consumers to accept content from the source of the application. In some cases this approach is designed to sell the distributor's products and services and in other cases to obtain demographic information of value to the distributor. Each copy of each embodiment of the present software application is assigned an enterprise identifier to enable the distributor of the application to track how it propagates. The application may be purchased, or it may be requested simply by completing a “request to download” form issued by an application service provider authorized to provide copies of the present application. This form requires basic information that the content provider may find useful for identifying the recipient such as name, email address, or identification number. Once the form is completed, the software application may be downloaded directly and immediately or by clicking on a link to a site where downloading can take place. The installed software will generate a personal identification number that it will subsequently attach to every transaction beginning with that recipient's copy of the present application. For example, if the recipient of the downloaded software obtains additional copies of the software for others, each of those additional copies will contain the recipient's personal identification number. In this way, the propagation of the present application can be tracked.

The user, upon receiving the downloaded copy of the present software application, may make one or more choices from a set of selections. For example, the user may want the present application to launch upon startup of the computer on which it resides. The user may select from a drop-down menu of available languages to choose the language in which the pop-up content will be delivered. The user may want to set the duration of the first time interval, namely, that interval that must pass before the next window appears, or “pops up”, on the computer monitor, as well as the pre-selected time interval until the window that has popped up closes. The available choices range from one pop-up per minute, for application testing purposes, to one per day and durations of one second to 60 seconds. As indicated above, the user may stay the closing of the pop-up window by moving the computer cursor over the window or by clicking on the “Pause” button. The user may also select the location on the computer monitor where the pop-up window will appear. There may be other preferences that the user may specify depending on the specific software application embodiment. For example, a user may want to be informed of news related to a particular country or of changes in stock prices in only a small number of stocks.

At the end of the installation sequence, the user's preferred settings over the default settings are displayed for a final check and the user's adjustment if necessary. Upon closing of the user settings window, the user is asked if the selected setting changes are to be applied. Once installed and the settings applied, the present application proceeds to cause the window to appear at the pre-selected frequency for the pre-selected duration to present the content from the pre-selected sources. There is no stimulus required to obtain the content; the pop-up window merely appears as scheduled with the current content the user has previously requested, and the next content when the window reappears after the scheduled time interval passes, and continues to do so automatically. The user may close the pop-up window without waiting for it to close automatically.

Also, upon installation, an icon will appear on the user's system tray, that appears typically in the lower right-hand corner of the user's computer screen. Right-clicking on the icon provides the user with quick links to specific application functions, presented in the form of a drop-down menu. These functions include, but are not limited to: “share this application with others”, “previous content displayed”, “next content displayed”, “user settings”, “help”, “disable this application” and “close”

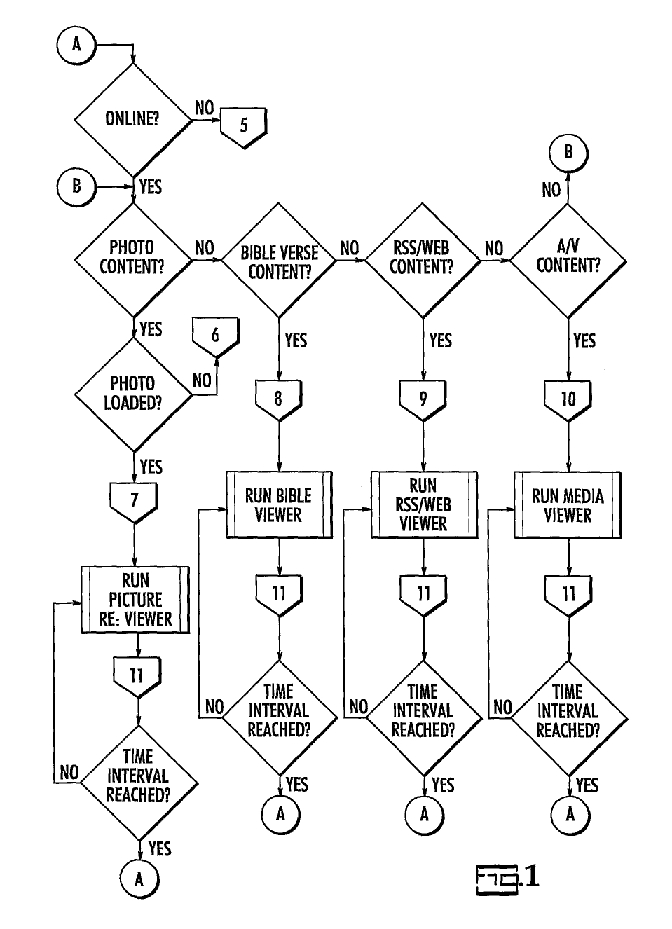

FIG. 1 is a flow chart showing the operation of a preferred embodiment of the present software application. When the present application is launched, the user will have a choice of default content or of content linked to one or more additional sets of sources, preferably three, identified by tabs on the application window. Other than having different sources of content, each tab operates in the same manner, as will presently be described.

At the end of the first time interval, the application is launched. If the computer is not connected to a network such as the internet or alternatively an intranet or local area network where there are sources of content the user has pre-selected, then the source of all content must be on the computer on which the software resides. Accordingly, if not on line, the application will run its offline version 5.

If online, the application will look for one or more pre-selected photos as default content, load them. To load the photos, an automated software wizard 6 walks the user through the process of locating photos on the user's computer and then enables the user to choose the pictures to be included in the pop-up window.

The photos are loaded by a photo viewer 7 that resizes them to fit within the pop-up window interface. The user can click on a magnifying glass icon in the window or click on the photos directly if the user wants to find the default photo viewer application. The photo is then run for the second duration interval by the run timer 11. When run timer 11 counts down the second interval, it closes the window and starts the first interval timer.

If the user has selected an embodiment that displays a verse from the Bible, the software application first checks to see if the Bible verses are available from the linked source. If they are, the application runs a Bible verse viewer 8. This viewer determines the choice for verse them. Then verses from within the chosen theme are chosen for random display until each one has been shown or the user changes the settings. If no theme is chosen, the default verses will apply, in which case the application will deliver verses each time the pop-up window is displayed. No verse will be displayed twice until every verse has been displayed once.

While Bible verse viewer is being run, timer 11 is counting down second interval. At the end of second interval, timer 11 closes the window and starts the first interval timer.

If the user has selected the RSS/Web content, the Run RSS/Web Viewer 9 is activated. This viewer resizes the user's chosen web page or RSS fee to fit within the pop-up window application interface. If the user clicks on a link on the pop-up window or on the page itself, the application searches for the resident device to find the default web browser or RSS reader application. Timer 11 counts down the second time interval while RSS/Web Viewer 9 runs. At the end of the second time interval, the pop-up window closes and the first time interval is started.

If there is a link to audio/visual (A/V content), a Run Media Viewer 10 will be activated. Viewer 10 also resizes the user's chosen video to fit within the application interface. If an audio file is chosen, the default image of an animated EQ graph will play. If the user clicks on the magnifying glass icon or on the pop-up window itself, the application searches the resident device to find the default photo viewer application. Meanwhile timer 11 is counting down second time interval. Once second time interval ends, timer 11 will close the pop-up window and start first time interval, and the application returns to the beginning, designated by the letter A.

There are few requirements placed on the choice of content provider: the content provider must define the format of the content and confirm that all content is formatted correctly; it must identify the content location and firm that the content is available for downloading; and it must confirm the security of the content to ensure that the first two requirements are maintained. If the selected content has links to other content, such as a link to an audio or video file, those links may also be included with the content retrieved by the present application. The content provider may chose to deliver content with such links to other content to the opening window for presentation of that content. The user may then click on the link in the pop-up window, which will follow a path specified by that link to acquire and present the linked content. Of course, the requirements for the content linked to the initially-requested content are the same as for the initially requested content itself. If these requirements are met by the content provider, the present software application can locate the content (again on the user's computer, a local area network computer, or the Internet) and re-format it to fit the pop-up window within the user's desktop.

If the content provider is the user's enterprise, such as the user's employer, the content provider may provide instant connectivity through assignment of links that drive the user to the desired content location. For example, if the enterprise wants the user to have instant access to the enterprise's newsletter, a button in the pop-up window that is a link to the newsletter will provide one-click access to the newsletter. The present application can provide for several such buttons. If the user clicks on that link, the present application opens a new window and follows the path pre-determined by the content provider that jumps to the location specified by the link. Once the user has “arrived” at the linked content location, all of the functionality of that location is available, including printing, forwarding, etc.

Built into every copy of the application is a link to the application provider at which the user can obtain additional copies of the application for family, friends, and co-workers from the application provider. With each copy ordered, the user's personal identification number and enterprise identifier are embedded in the transaction identification number so that the spread of the present application can be easily tracked from any enterprise and any individual. These transactions are completed through secure socket layer (SSL) technology and other protocols required for electronic commerce.

The user may click on a viral propagation link to have the present application open a new window that contains a link allowing the user to follow a path to the application service provider. Once at the service provider's website, all of the functionality of that site is available to the user, such as purchasing and forwarding. For example, one embodiment of the present application may be information about new music releases of a sort requested by the user. This specific embodiment of the present application may be provided by the online outlet of a music vendor. At intervals, the user will be made aware, when the present application launches a pop-up window, that a tracked artist has released a new single or album. Clicking on a link in the pop-up window may permit a sample to be heard from the newly release song, delivered via an audio data file perhaps also with an accompanying music video data file. By clicking on another link in the pop-up window, the user launches a window leading to the vendor's online store where the music just demonstrated can be purchased.

Another embodiment of the present software application is for obtaining content regarding low cost airfares. For example, suppose the user is searching for an airfare to a vacation destination and wishes to be made aware of the lowest fares to that destination at intervals during the day. Once a fare is brought to the user's attention by a pop-up window launched by the present software application, the user can click on a button in that window that links the user to the airline's online reservation service where the user can immediately book the flight at the stated fare.

It is intended that the scope of the present invention include all modifications that incorporate its principal design features, and that the scope and limitations of the present invention are to be determined by the scope of the appended claims and their equivalents. It also should be understood, therefore, that the inventive concepts herein described are interchangeable and/or they can be used together in still other permutations of the present invention, and that other modifications and substitutions will be apparent to those skilled in the art from the foregoing description of the preferred embodiments without departing from the spirit or scope of the present invention.

1. A device for delivering changing content to a user of a personal computer, cellular telephone or PDA, connected to a network, said device having a monitor with a screen, said device comprising:
a software application that opens a window on said screen of said monitor;
links carried by said software application to a source of changing content accessible from said computer, said changing content including current content and next content;
a first timer carried by said software application that counts down a pre-selected first time interval, said software application opening said window when said first timer reaches the end of said first time interval, said software application then following said links to said changing content and displaying in said window said current content; and
a second timer carried by said software application that counts down a pre-selected second time interval beginning when said first time reaches the end of said first time interval, said software application then closing said window and terminating said links to said current content when said second time interval ends, said software application then immediately initiating said first timer to count down said pre-selected first time interval before opening said window and following said links to display said next content.

2. The device as recited in claim 1, wherein said personal computer, cellular telephone or PDA has a user interface that includes a cursor, and wherein placement of said cursor over said window stays said second timer.

3. The device as recited in claim 1, wherein said pre-selected first time interval is user-specified.

4. The device as recited in claim 1, wherein said pre-selected second time interval is user-specified.

5. The device as recited in claim 1, wherein said changing content is a set of facts, said current content being a first fact and said next content being a next fact.

6. The device as recited in claim 1, wherein said changing content is evolving information, said current content being currently known information about said event and said next content being information that will be known about said event at the expiration of said pre-determined first time interval.

7. The device as recited in claim 1, wherein said window covers a minor portion of said screen of said monitor.

8. The device as recited in claim 1, wherein said changing content includes text files.

9. The device as recited in claim 1, wherein said changing content includes audio files.

10. The device as recited in claim 1, wherein said changing content includes video files.

11. The device as recited in claim 1, wherein said changing content includes links to linked content.

12. The device as recited in claim 1, wherein said changing content is user-selected.

13. A method for delivering changing content to a user of a computer, cellular telephone or PDA that is connected to a network, said method comprising the steps of:
(a) designating by a user of a computer, cellular telephone or PDA a source of content connected to a network;
(b) opening a window on the screen of a computer, cellular telephone or PDA;
(c) loading current content from said source of content in said opened window for a first time interval;
(d) closing said opened window at the end of said first time interval;
(e) waiting for a second time interval beginning immediately at the end if said first time interval;
(f) opening said window on said screen of said computer, cellular telephone or PDA;
(g) loading next content from said source of content in said opened window for said first time interval;
(h) waiting for said second time interval; and
(i) repeating steps (b) through (h) as soon as said second time interval has elapsed.

14. The method as recited in claim 13, further comprising pre-selecting said first and said second time intervals of time.

15. The method as recited in claim 13, wherein said window occupies a portion of said screen and wherein said method further comprises the step of pre-selecting said portion for said window.

16. The method as recited in claim 13, wherein said designating step further comprises designating a source of content that includes audio files and video files.

17. The method as recited in claim 13, further comprising the step of staying said second time interval by moving a cursor over said window or selecting the “Pause” option.

18. The method as recited in claim 13, wherein said content includes a link to said source's website, and wherein said method further comprises the steps of:
(a) activating said link to view said source's website; and
(b) obtaining additional information about said current content in order to make a purchasing decision with respect to said current content.

19. A method of delivering changing content to a user of a computer that is connected to a network, said method comprising the steps of:
(a) downloading a software application to a computer, cellular telephone or PDA on a network, said software application capable of allowing the user of a device on said network to designate a source of content connected to a network, open a window on the screen of said device, load current content from said source of content in said opened window for a first time interval, load said opened window at the end of said first time interval, wait for a second time interval that begins when said first time interval ends, open said window on said screen of said device as soon as said second time interval ends, load next content from said source of content in said opened window for said first time interval, wait for said second time interval;
(b) assigning an enterprise number to said downloaded software application;
(c) allowing said user to obtain additional copies of said software application for others;
(d) assigning said enterprise number and an additional numbers to said additional copies; and
(e) tracking distribution of said copies of said software application by said enterprise number and said additional numbers.

20. A method of adding, modifying and updating the enterprise content made available to a user of the software application of claim 1, through a web-enabled, password-protected administrative portal, said method comprising the steps of:
(a) creating a database of links to enterprise content made available to users of said software application, wherein access to said database is provided at different levels ranging from the broad spectrum permission provided to the highest ranking administrative personnel to very limited access granted to departmental personnel, according to a predetermined hierarchy;
(b) enabling the addition, deletion and modification of enterprise content through an interface made available as an active server age (ASP) which is accessible through the said administrative portal;
(c) automatic updating of every end-user installation of said software application through the modification of the drop-down menus for content selection within each user's personal interface, so that, when said enterprise content is modified, the end-user applications will reflect the update in the first pop-up that appears subsequent to the modification.

21. A method of tracking delivered content to a user of a personal computer that is connected to a network, said method comprising the steps of:
(a) downloading a software application to said personal computer on said network, said software application being capable of tracking the usage of said personal computer on said network so that a content provider may ascertain individual usage statistics and individual preferences for content delivered through said network using said software application;
(b) assigning an individual tracking number (ITN) to said downloaded software application;
(c) including said originating ITN with additional distributed copies of said downloaded software application in order to track originating source;
(d) capturing said usage statistics of every individual user of said downloaded software application in combination with said ITN;
(e) enabling the content provider to view the said captured usage statistics, real time and on-demand;
(f) displaying said usage statistics in the form of a data table and graphs through a password-protected administration portal.
